(19) United States
(12) Patent Application Publication
(10) Pub. No.: US 2018/0363591 A1
(43) Pub. Date: Dec. 20, 2018

(54) Low Pressure Gaseous Fuel Injector Shroud

(71) Applicant: GE Oil & Gas Compression Systems, LLC, Houston, TX (US)

(72) Inventors: John Charles Etcheverry, Houston, TX (US); Mark Patterson, Houston, TX (US)

(21) Appl. No.: 15/622,603

(22) Filed: Jun. 14, 2017

(51) Int. Cl. F02M 21/02

(52) U.S. Cl. CPC F02M 21/0257; F02F 1/242; F02M 21/0275

(57) ABSTRACT

Systems, devices, and methods are provided for improving fuel distribution in gas fired reciprocating internal combustion engines (RICE) that use direct inject fuel gas injector systems. The systems, methods, and devices facilitate directing fuel flow into a combustion chamber of the engine, which can create a more homogenous fuel/air mixture, resulting in more efficient combustion and a reduction in NOₓ, volatile organic compounds (VOCs), and carbon monoxide (CO), emissions.

### FIELD

Shrouds for low pressure fuel injectors are provided, and in particular, devices, systems, and methods are provided for directing gaseous fuel flow into a combustion chamber.

### BACKGROUND

Current direct inject fuel gas injector systems can generally be categorized as low pressure systems or high pressure systems. Compared to low pressure systems, high pressure systems can provide better fuel penetration and improved homogeneity of a fuel/air mixture. However, high pressure systems can be much more expensive to purchase and maintain than low pressure systems. Converting a low pressure system to a high pressure system can also require expensive system level upgrades in applications such as, e.g., pipeline gas compression. In other applications, it may not be possible to use a high pressure system due to lack of a high pressure gas source.

### SUMMARY

Shrouds for use with lower pressure fuel injectors, low pressure fuel injectors assemblies, and methods for directing gaseous fuel flow into a combustion chamber are provided. In one embodiment, a shroud for a gas fuel injector is provided that can include a body having an open proximal end configured to receive fuel from a fuel injector and a distal end configured to deliver the fuel to a combustion chamber of an engine. The distal end can have a primary opening extending therethrough. The primary opening can be configured to be sealed by a valve during injection of a fuel. The distal end can include at least one secondary opening extending therethrough and positioned radially outward of the primary opening. The at least one secondary opening can be configured to pass fuel therethrough when the primary opening is sealed by a valve.

The shroud can vary in a number of ways. For example, the at least one secondary opening can be configured to direct fuel radially outward from the at least one secondary opening. As another example, the body of the shroud can have a substantially cylindrical geometry. As another example, the distal end of the body of the shroud can be configured to couple with a cylinder head of an engine, adjacent to a fuel intake port. As yet another example, a portion of the body of the shroud can configured to be received within a fuel intake port of an engine.

In some implementations, the at least one secondary opening can have a longitudinal axis that can be angled radially outward from a central axis of the primary opening. In other implementations the at least one secondary opening can be a longitudinal slot that extends through the body of the shroud. As another example, the at least one secondary opening can comprise a plurality of openings positioned radially around the primary opening.

In another embodiment, a fuel injector is provided that can include a housing defining a first passage configured to allow fuel to flow therethrough. The housing can include a sealing element. The fuel injector can also include a valve that can be movable between a first position in which the valve forms a seal with the sealing element and a second position. The fuel injector can further include a shroud that can have a proximal end coupled to the housing. The shroud can have a central passage configured to be substantially sealed by the valve when the valve is in the second position, and at least one fuel passage configured to allow fuel to flow therethrough when the central passage is sealed by the valve.

The fuel injector can vary in a number of ways. For example, the at least one fuel passage can be configured to direct fuel radially outward from the at least one fuel passage. As another example, the body of the shroud can have a substantially cylindrical geometry. In some implementations, the at least one fuel passage can be angled radially outward from a central axis of the primary passage. In other implementations the at least one fuel passage can be in the form of at least one longitudinal slot that extends through the body of the shroud. As another example, the at least one fuel passage can be in the form of a plurality of passages positioned radially around the central passage.

In another aspect, a method for injecting fuel into an engine is provided. The method can include delivering a gaseous fuel to a fuel inlet passage of a fuel injector, moving a sealing member from a first position to a second position to thereby open the fuel inlet passage and to seal a first passage of a shroud. The gaseous fuel can flow from the fuel inlet passage through at least one secondary passage in the shroud such that the fuel flows into a combustion chamber. The method can further include moving the sealing member from the second position to the first position, thereby closing the fuel inlet passage, and igniting the fuel to cause combustion.

The method can vary in a number of ways. For example, the sealing member can move away from a sealing element to open the fuel passage when it is moved from the first position to the second position. In some implementations, the fuel can be directed radially outward from a central axis of the first passage as it flows into the combustion chamber. In other implementations, a flame front from the combustion chamber can enter the first passage of the shroud. The flame font can burn fuel within the shroud.

### DESCRIPTION OF DRAWINGS

FIG. 1A is a cross-sectional view of one exemplary embodiment a 2-stroke gas fired reciprocating internal combustion engine (RICE);

FIG. 1B is an enlarged cross-sectional view of a portion of the engine shown in FIG. 1A;

FIG. 2A is a side view of an exemplary embodiment of a fuel injector shroud of the engine of FIG. 1A;

FIG. 2B is a bottom view of the fuel injector shroud shown in FIG. 2A;

FIG. 2C is a side cross-sectional view of the fuel injector shroud shown in FIG. 2A;

FIG. 3A is a side view of the fuel injector shroud and fuel injector of FIG. 1A, with a valve stem at a first position;

FIG. 3B is a side view of the shroud and the fuel injector shown in FIG. 3A, with the valve stem at a second position;

FIG. 4 is a bottom perspective view of another exemplary embodiment of a fuel injector shroud; and

FIG. 5 is a cross-sectional view of a portion of another exemplary embodiment a 2-stroke gas fired RICE.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Some gas fired internal combustion engines utilize direct inject fuel gas injector systems to inject fuel into a combustion chamber of the engine. The fuel within the combustion chamber can be ignited to cause combustion, which can displace a piston. The motion of the piston creates mechanical energy that can be harnessed. Direct inject fuel gas injector systems can generally be categorized as low pressure systems, which can deliver fuel at approximately ˜30-60 psig, or high pressure systems, which can deliver fuel at approximately ˜100-500 psig. In some circumstances, low pressure systems can provide relatively low fuel penetration, and poor fuel/air mixing, in the combustion chamber, which can result in inefficient combustion and increased emissions. One way to correct this is to use a shroud, or cap, to direct flow from the injector into the combustion chamber. The shroud can maximize fuel penetration, improve free jet mixing of a gas stream, and create a more homogeneous fuel/air mixture in the combustion chamber by optimizing the injection direction and spread of gas into the chamber. This can allow for better fuel distribution as compared to other, similar low pressure injectors. The improved fuel distribution can result in more efficient combustion and reduced emissions.

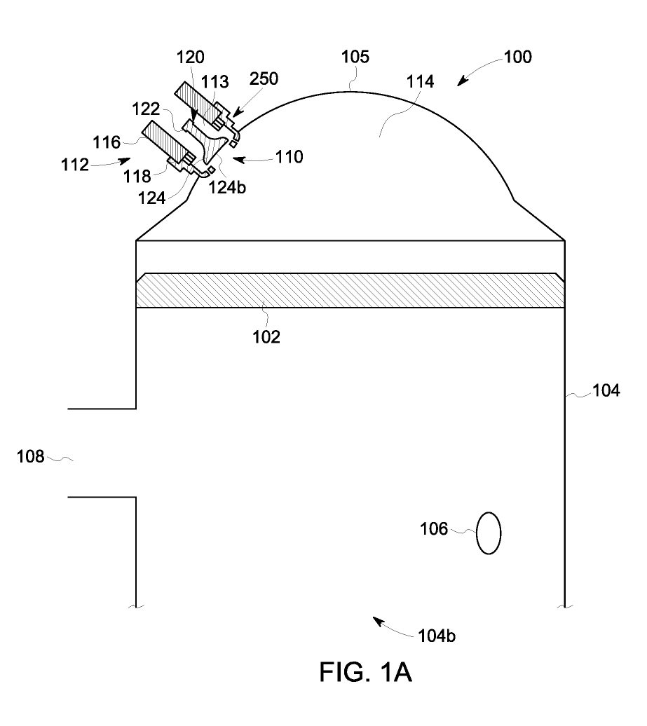

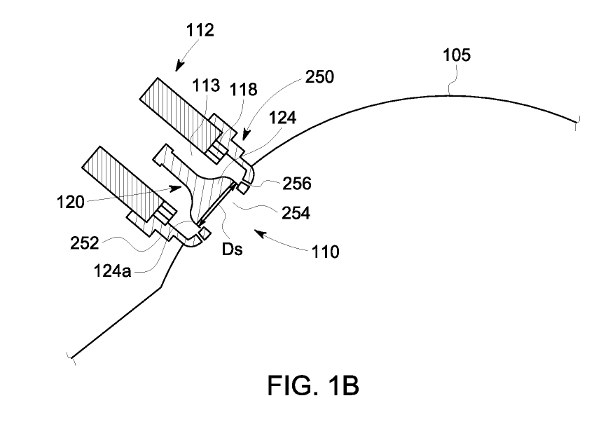

FIG. 1A illustrates a 2-stroke gas fired RICE 100. The engine 100 can generally include a cylinder 104 having a piston 102 disposed therein, and a cylinder head 105. The piston 102, cylinder 104, and cylinder head 105 can define an enclosed volume of a combustion chamber 114. The cylinder 104 can also include an air intake port 106 for delivering air to the combustion chamber 114, and an exhaust port 108 that can allow for expulsion of exhaust from the combustion chamber 114. The cylinder head 105 can include a fuel intake port 110 that can facilitate fuel delivery from a fuel injector 112 into the combustion chamber 114. The fuel injector 112 can include a housing 116 having a sealing element 118 coupled thereto, and a valve member 120. The fuel injector 112 can function to control injection a fuel gas such as, e.g., natural gas, into a combustion chamber 114 of the engine 100. As further shown in FIG. 1A, a shroud 250 can coupled between the fuel injector 112 and the combustion chamber 114. As will be discussed in more detail below, the shroud 250 can be configured to direct flow in a controlled manner into the combustion chamber. While not shown, the engine can also include a spark plug (not shown) and/or other ignition system that can extend through, or be coupled with, an ignition port (not shown) on the cylinder head 105, on the same side of the piston 102 as the fuel injector 112. The spark plug (not shown) and/or other ignition system can function to ignite fuel within the combustion chamber to cause combustion.

The fuel injector 112 can have a variety of configurations and any fuel injector known in the art can be used with the shrouds disclosed herein. As shown in FIG. 1A, the housing 116 of the fuel injector 112 can generally be cylindrical with an inner lumen extending therethrough. At least a portion of the inner lumen can function as a fuel inlet passage 113. As shown in FIGS. 1A-1B, a distal end of the fuel injector 112 can be received within and/or releasably coupled to the shroud 250, as will be discussed in more detail below. The housing 116 of the fuel injector 112 can also have the sealing element 118 coupled thereto, and the valve member 120 disposed therein. The sealing element 118 can have a circular, or ring-shaped, geometry, and can be seated within the housing 116 of the fuel injector 112, or at an end of the housing 116 of the fuel injector. The valve member 120 can also have a variety of configurations. For example, the valve member 120 can be in the form of a poppet valve, ball valve, a needle valve, etc. disposed in the housing. In the illustrated embodiment, the valve member 120 is in the form of a poppet valve. The valve member 120 can function to open or close the fuel inlet passage 113 and to ensure that fuel travels through the secondary passages 256 during fuel injection. Accordingly, the valve member 120 can include a sealing member 124 having a diameter Ds disposed at an end of a valve stem 122. The sealing member 124 can have a first surface 124a that can form a seal with the sealing element 118, and a second surface 124b that can seal the central passage 254.

In operation, with reference to FIG. 1A, the piston 102 can travel toward a lower end 104b of the cylinder 104, below the air intake port 106, and air can be introduced into the combustion chamber 114. The piston 102 can then move toward the cylinder head 105, and fuel can be injected into the combustion chamber 114 by the fuel injector 112. When the piston 102 is at an appropriate position, the fuel can be ignited to cause combustion, thereby forcing the piston toward the lower end 104b of the cylinder 104. The piston 102 can travel past the exhaust port 108, thereby letting exhaust exit the chamber 114, and past the air intake port 106, thereby letting air into the combustion chamber 114, and the process can be repeated. One skilled in the art will appreciate that the piston 102 can have a connecting rod attached thereto, and the connecting rod can be coupled to a crankshaft, which can be disposed within a crank housing that can be connected to the lower end 104b of the cylinder 104. Exemplary methods of injecting fuel into the combustion chamber 114 will be discussed in more detail below.

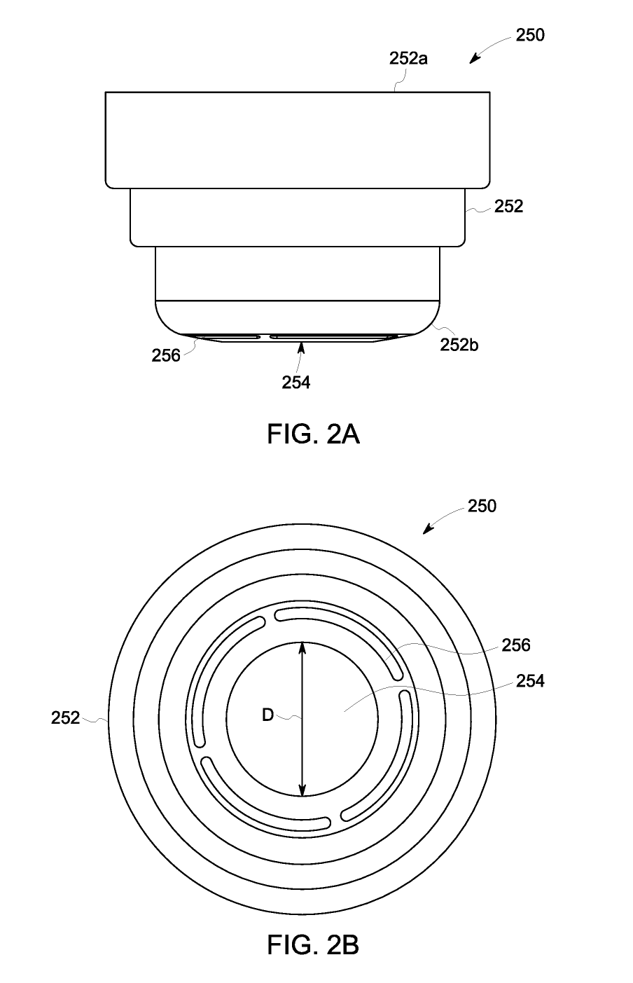

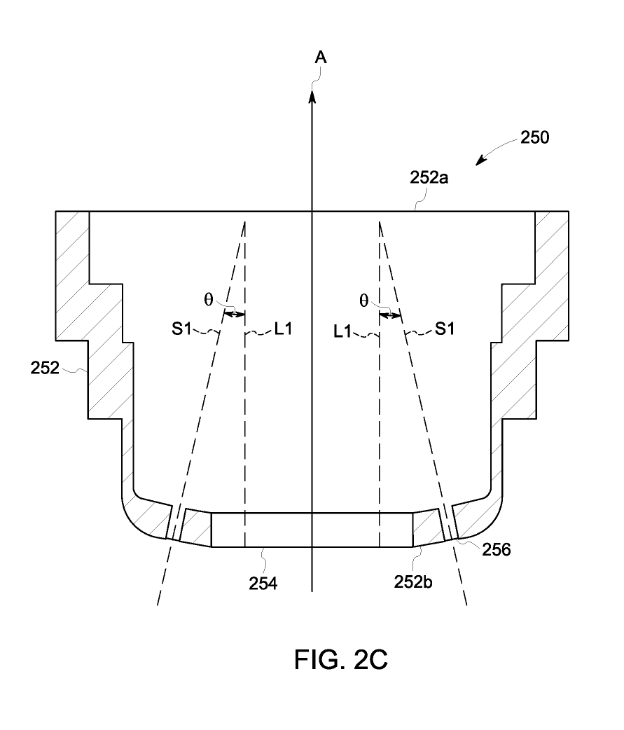

As indicated above, the shroud 250 can couple between the fuel injector 112 and the combustion chamber 114 for delivering fuel from the fuel injector 112 to the combustion chamber 114. The shroud 250 can have various configurations. In the illustrated embodiment, as shown in more detail in FIGS. 2A-2C, the shroud 250 can have a substantially cylindrical body 252 with a proximal end 252a and a distal end 252b. The proximal end 252a can be configured to couple to the housing 116 of the fuel injector 112, and various mating techniques can be used, such as a mechanical engagement, e.g., threaded connection, a snap-fit, a press-fit or interference fit, welding, etc. In the illustrated embodiment, the proximal end 252a is open such that the shroud 250 can mate with the housing of a fuel injector, such as housing 116 of fuel injector 112, and such that it can receive a valve member such as, e.g., valve member 120. Although the proximal end 252a is shown to have a circular opening, the shape of the proximal end 252a can vary depending on the configuration of the fuel injector. The distal end 252b of the shroud 250 can be configured to couple to the combustion chamber 114. For example, the housing 116 of the fuel injector can press the distal end 252b of the shroud 250 against a portion of the fuel intake port 110. In some embodiments, there can be a gasket between the distal end 252b of the shroud 250 and the portion of the fuel intake port 110 that the distal end 252b contacts. In some embodiments, the fuel intake port 110 can be located on the cylinder 104 rather than the cylinder head 105. However, the shroud 250 can generally function similarly, regardless of whether the intake port 110 is on the cylinder head 105 or on the cylinder 104.

In an exemplary embodiment, the shroud 250 is configured to direct fuel in a controlled manner from the fuel injector 112 into the combustion chamber 114. While various techniques can be used to control fuel flow, in one embodiment as shown the shroud 250 can include a central primary passage 254 and at least one secondary passage 256, which can be referred to as a fuel passage, disposed adjacent to the central passage 254. In the illustrated embodiment, the shroud 250 includes four secondary passages 256 disposed radially outward of and around the central passage 254. However, the shroud 250 can include one or more secondary passages 256.

The central and secondary passages 254, 256 can have any geometry that suits the described purpose. For example, the central passage 254 can be circular as shown, or it can be another shape, such as oval, square, rectangular, etc. The secondary passages 256 can also have various shapes. In an exemplary embodiment, the secondary passages 256 can each be in the form of an elongate slot.

As shown in FIGS. 2B-2C, the central passage 254 can have a diameter D and a central axis A. In a preferred embodiment, the diameter D of the central passage 254 can be less than the diameter Ds of the sealing member 124. As illustrated in FIG. 2B, the secondary passages 256 can have a length L and a width W. In some embodiments, it can be desirable to have a length to width ratio of L/W≥1. However, in other embodiments, a length to width ratio of L/W≥0.5 can be desirable. As shown in FIG. 2C, the secondary passages 256 can have center lines S1, or center planes, that can be oriented at an angle θ relative to the central axis A, such that center lines S1 and central axis A are not parallel. In the illustrated examples, lines L1 are parallel to central axis A such that the angle θ formed between center lines S1 and lines L1 is the same angle θ that would be formed between center lines S1 and central axis A. In other words, the secondary passages 256 can be oriented at the angle θ relative to the central axis A. As shown in FIG. 2C, the angle θ can result in the secondary passages 256 being angled radially outward from the central axis A. In some embodiments, the angle θ can be in the range of approximately 10°-45°. Additionally, each of the secondary passages 256 can have different angles θ.

Although the shroud 250 and fuel injector 112 are described as independent components, in some embodiments, the shroud 250 can be integral with the housing 116 of the fuel injector 116. Therefore, the fuel injector can include the central passage 254 and the secondary passages 256 as described above with regard to the shroud 250.

In use, the configurations of the passages in the shroud 250 can function to direct a flow of fuel from the fuel injector 112 into the combustion chamber 114 during fuel injection. Directed fuel flow can create more air entrainment and can result in improved mixing and homogeneity of a fuel/air mixture in the combustion chamber 114. In other words, a larger portion of the fuel/air mixture can be at a desired equivalence ratio, and the equivalence ratio can have a smaller standard deviation.

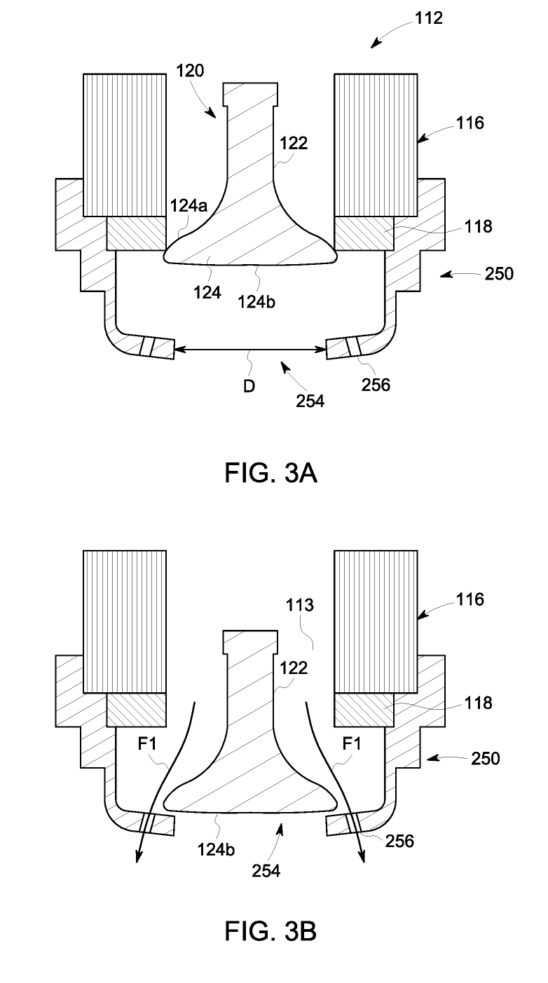

FIGS. 3A-3B show the fuel injector 112 with the valve stem 122 at various positions during a fuel injection process. Prior to fuel injection, the valve member 120 can be in a first position such that the first surface 124a forms a seal with the sealing element 118, as shown in FIG. 3A. During fuel injection, the valve member 120 can move to a second position, shown in FIG. 3B, such that the second surface 124b of the sealing member 124 closes the central passage 254 of the shroud 250, thereby substantially preventing fuel from flowing through the central passage 254, while leaving the secondary passages 256 substantially open. With the valve member 120 in the second position, fuel can flow through the fuel inlet passage 113 in the fuel injector 112, and through secondary passages 256 in the shroud 250, as indicated by lines F1. The angle θ of the secondary passages 256, described with regard to FIG. 2C, can aid in directing fuel flow in a desired direction into the combustion chamber. In this case, given the angle θ of the passages, the flow can be directed radially outward from central axis A1. As the fuel is forced through the secondary passages 256, the secondary passages 256 can function to increase an injection velocity of the fuel into the combustion chamber, which can aid in mixing.

Prior to combustion, or during an initial phase of combustion, the valve member 120 can move back to the first position, thereby uncovering the central passage 254 and forming a seal with the sealing element 118. In order to ensure that any fuel that can remain in the shroud 250 can be burned during combustion, the central passage 254, or cleanout hole, can function to allow a flame front and charge motion from combustion to burn, or sweep out, an enclosed volume of the shroud 250. This can prevent unburned hydrocarbons from collecting within the shroud 250, and can help reduce emissions by ensuring a complete combustion.

One skilled in the art will appreciate that the valve member 120 can be moved from the first position to the second position, and vice versa, in a number of ways. For example, the valve member 120 can be coupled to a cam/lifter linkage that can be coupled to a crank shaft which can be coupled to the piston 102 by a connecting rod. As the piston 102 moves back and forth within the cylinder 104, the crank shaft can rotate which can move the cam/lifter linkage such that the valve member 120 can move between the first and second positions at appropriate times.

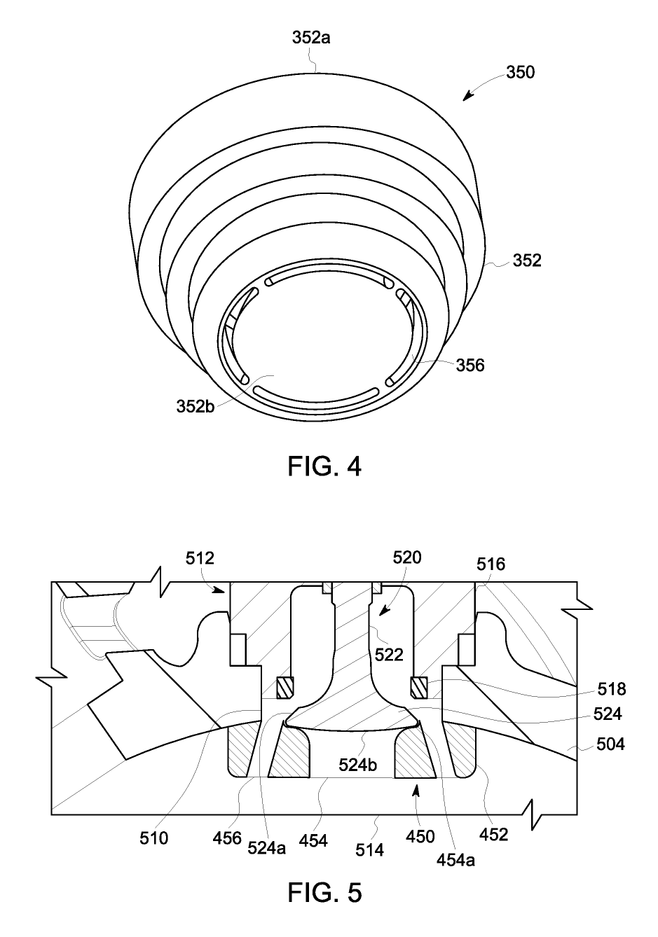

FIGS. 4 and 5 show other exemplary embodiments of shrouds 350, 450 that can be used to direct fuel into a combustion chamber. The shroud 350 shown in FIG. 4 can generally be similar to shroud 250, but it does not include a central passage. The shroud 350 can have a substantially cylindrical body 352 having an open proximal end 352a, and a distal end 352b. The distal end can have secondary passages 356, similar to secondary passages 256 of the shroud 250.

FIG. 5 shows a portion of an engine 500 having a fuel injector 512 that can function cooperatively with the shroud 450. The engine 500 can generally be similar to engine 100, and can include a piston (not shown), a cylinder head 505, a fuel intake port 510, and the fuel injector 512. In this embodiment, the shroud 450 can be coupled to the cylinder head 505 adjacent the fuel intake port 510. As an example, the shroud 450 can be bolted to a cylinder head 505 adjacent to the fuel intake port 510. In some embodiments, the shroud 250 can be integral with a cylinder head.

The fuel injector 512 can generally be similar to fuel injector 112, and can function to inject a gas such as, e.g., natural gas, into a combustion chamber 514 of the engine 500. The fuel injector 512 can include a housing 516, a sealing element 518, and a valve member 520. The valve member 520 can include a valve stem 522 and a sealing member 524. The sealing member can have a first surface 524a that can form a seal with the sealing element 518, and a second surface 524b that can seal the central passage 454.

As shown in FIG. 5, the shroud 450 can have a cylindrical disk-shaped body 452 having a central passage 454 and at least one secondary passage 456 extending therethrough. In this embodiment an opening 454a of the central passage 454 that is proximal to the sealing member 524 can have a curvature that is complementary to that of the second surface 524b of the sealing member 524. The curvature of the opening 454a can facilitate formation of an improved seal between the second surface 524b of the sealing member 524 and the opening 454a of the central passage 454. The curvature can also be recessed within the body 252 of the shroud 250, which can ensure that the secondary passages 456 remain substantially unblocked when the sealing member 524 blocks the central passage 454.

In the illustrated embodiment, the housing 516 of the fuel injector 512 can be releasably coupled to the cylinder head 505 at the fuel intake port 510, and the shroud 450 can be disposed over the fuel intake port 510 such that it is in the flow path of fuel traveling from the fuel injector 512 the combustion chamber 514. The fuel injector 512, including the valve member 520, can function with the shroud 450 in the same manner as that described with regard to fuel injector 112, valve member 120, and shroud 250.

Although the shrouds 250, 350, 450 have been described in the context of a two-stroke engine, the shrouds 250, 350, 450 can be used with any direct inject gas fuel injector and/or engine. In some embodiments, the shrouds 250, 350, 450 can be integral with a cylinder or a cylinder head of an engine.

As described above, the use of a shroud can help maximize fuel penetration, improve free jet mixing of a gas stream, and create a more homogeneous fuel/air mixture in the combustion chamber by optimizing the injection direction and spread of gas into a combustion chamber. This can allow for better fuel distribution as compared to other, similar low pressure injectors. The improved fuel distribution can result in more efficient combustion, and reduced emissions. For example, a more homogenous mixture of fuel and air within a combustion chamber can minimize lean and rich fuel pockets, which can reduce NOₓ, volatile organic compounds (VOCs), and carbon monoxide (CO), emissions.

When comparing a high pressure fuel injector and a shrouded low pressure fuel injector, preliminary analyses indicate that similar percentages of a fuel/air mixture in a combustion chamber would be at a desired equivalence ratio directly prior to combustion. Moreover, the shrouded low pressure fuel injector produced a standard deviation of the equivalence ratio that was approximately equal to that of the high pressure fuel injector, and approximately half of that of a low pressure unshrouded fuel injector.

Therefore, using a shroud with a low pressure fuel injection system can allow for comparable performance to a high pressure fuel injection system, while substantially reducing costs and maintenance associated with converting a low pressure injection system to a high pressure injection system. It can also provide a viable alternative when converting from a low pressure injection system to a high pressure injection system is not feasible.

Other embodiments are within the scope and spirit of the disclosed subject matter.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

Approximating language, as used herein throughout the specification and claims, may be applied to modify any quantitative representation that could permissibly vary without resulting in a change in the basic function to which it is related. Accordingly, a value modified by a term or terms, such as “about” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

What is claimed is:

1. A shroud for a gas fuel injector, comprising:
a body having an open proximal end configured to receive fuel from a fuel injector and a distal end configured to deliver the fuel to a combustion chamber of an engine, the distal end having a primary opening extending therethrough, the primary opening being configured to be sealed by a valve during injection of a fuel, and the distal end including at least one secondary opening extending therethrough and disposed radially outward of the primary opening, the at least one secondary opening being configured to pass fuel therethrough when the primary opening is sealed by a valve.

2. The shroud of claim 1, wherein the at least one secondary opening is configured to direct fuel radially outward from the at least one secondary opening.

3. The shroud of claim 1, wherein the body of the shroud has a substantially cylindrical geometry.

4. The shroud of claim 1, wherein the body of the shroud is configured to couple with a cylinder head of an engine, adjacent to a fuel intake port.

5. The shroud of claim 1, wherein a portion of the body of the shroud is configured to be received within a fuel intake port of an engine.

6. The shroud of claim 1, wherein the at least one secondary opening has a longitudinal axis that is angled radially outward from a central axis of the primary opening.

7. The shroud of claim 1, wherein the at least one secondary opening is a longitudinal slot that extends through the body of the shroud.

8. The shroud of claim 1, wherein the at least one secondary opening comprises a plurality of openings positioned radially around the primary opening.

9. A fuel injector comprising:
a housing defining a first passage configured to allow fuel to flow therethrough, the housing including a sealing element;
a valve movable between a first position in which the valve forms a seal with the sealing element, and a second position;
a shroud having a proximal end coupled to the housing, the shroud including a central passage configured to be substantially sealed by the valve when the valve is in the second position, and at least one fuel passage configured to allow fuel to flow therethrough when the central passage is sealed by the valve.

10. The fuel injector of claim 9, wherein the at least one fuel passage is configured to direct fuel radially outward from the at least one fuel passage.

11. The fuel injector of claim 9, wherein the at least one fuel passage is angled radially outward from a central axis of the primary passage.

12. The fuel injector of claim 9, wherein the at least one fuel passage comprises at least one longitudinal slot that extends through the body of the shroud.

13. The injector of claim 9, wherein the at least one fuel passage comprises a plurality of passages positioned radially around the central passage.

14. The fuel injector of claim 9, wherein the body of the shroud has a substantially cylindrical geometry.

15. A method for injecting fuel into an engine, comprising:
delivering a gaseous fuel to a fuel inlet passage of a fuel injector;
moving a sealing member from a first position to a second position to thereby open the fuel inlet passage and to seal a first passage of a shroud, wherein the gaseous fuel flows from the fuel inlet passage through at least one secondary passage in the shroud such that the fuel flows into a combustion chamber;
moving the sealing member from the second position to the first position, thereby closing the fuel inlet passage; and
igniting the fuel to cause combustion.

16. The method of claim 15, wherein the sealing member moves away from a sealing element to open the fuel passage when it is moved from the first position to the second position.

17. The method of claim 15, wherein the fuel is directed radially outward from a central axis of the first passage as it flows into the combustion chamber.

18. The method of claim 15, wherein a flame front from the combustion chamber enters the first passage of the shroud.

19. The method of claim 18, wherein the flame front burns fuel within the shroud.
